(19) United States
(12) Patent Application Publication
(10) Pub. No.: US 2023/0156610 A1
(43) Pub. Date: May 18, 2023

(54) METHOD AND APPARATUS FOR CONTROLLING UPLINK TRANSMISSION POWER

(71) Applicant: Sterlite Technologies Limited, Gurugram (IN)

(72) Inventors: Nitin Kumar, Gurugram (IN); Manish Jamwal, Gurugram (IN); Gurpreet Singh, Gurugram (IN)

(73) Assignee: Sterlite Technologies Limited, Gurugram (IN)

(21) Appl. No.: 17/705,349

(22) Filed: Mar. 27, 2022

(30) Foreign Application Priority Data
Nov. 18, 2021 (IN) 202111053021

(51) Int. Cl. H04W 52/14; H04W 52/24

(52) U.S. Cl. CPC H04W 52/146; H04W 52/242

(57) ABSTRACT

The present disclosure provides a method and apparatus controlling an uplink (UL) transmission power of at least one user equipment (UE) operating in a wireless communication network (100) comprising a plurality of UEs (104a-104c) and a base station (102). The method includes calculating an operating ratio for each UE from said plurality of UEs, determining whether said operating ratio for each UE meets a predefined UL power transmission threshold, and instructing said at least one UE to manage UL transmission power based on said determination.

### TECHNICAL FIELD

The present invention relates generally to wireless communication, and more specifically, to uplink transmission power control and power allocation across multiple transmit antennas in a wireless communication network.

### BACKGROUND

A power control mechanism in case where a transmitter and a receiver are connected wirelessly requires a use of very high gain amplifier on the transmitter and blast huge, powered signal to the receiver. This power control mechanism would be good when the receiver and the transmitter is in a reasonable distance. However, if the distance between receiver and transmitter is too close, then a strong signal from the transmitter saturates the receiver.

Currently, in order to avoid the saturation of the receiver due to reception of the strong signal, a power of an amplifier circuitry of the transmitter is tune down to an appropriate level. Nevertheless, this method of tuning down the power of the amplifier circuitry is dependent on distance and channel condition ((Humidity, precipitation, buildings)) between the transmitter and the receiver. Hence, change in the distance and channel condition would require corresponding tuning down the power, which is tedious involving increase in time/resource (i.e., manual effort) consumption.

Alternatively, other existing power control mechanisms include an open loop power control and close loop power control each of which explained in FIG. 1A and FIG. 1B, respectively.

As illustrated in FIG. 1A, in the Open Loop Power Control, there is no feedback either from a user equipment (UE) to a base station (BS) or from the BS to the UE. In case of a Code Division Multiple Access (CDMA) system, there is a dedicated pilot channel provided for channel estimation. It is transmitted by the BS to all the subscribers. The UE receives the pilot channel and estimates the power strength. Based on this estimate, the UE adjusts the transmit power accordingly. Thus, during this open loop power control, it is assumed that both forward link/DL (downlink) (from BS to UE) and reverse link/UL (uplink) (from UE to BS) are correlated.

As illustrated in FIG. 1B, in the Closed Loop Power Control, feedback is used for adjusting the transmit power level. The BS receives the UL signal from the UE. Based on this received power level as well as other parameters such as SNR (Signal-to-Noise Ratio) and BER (Bit Error Rate), the BS determines what is the optimum power level that the UE needs to transmit to achieve effective communication link performance. This estimated power level is communicated to the UE by the BS over the control channel using Transmit Power Control (TPC) commands. Thus, the UE adjusts the power level accordingly using the feedback provided by the BS. Often the UE estimates the BS power level and communicates the BS to adjust its power level to achieve effective reverse link performance.

Although, the closed loop power control mechanism is effective over the open loop power control mechanism, however, the current closed loop power management does not take into account interference, all UEs irrespective of their distance from the BS are instructed to send power above a fixed threshold, causing interference due to high power transmission by near-BS UEs. Some of the prior art references are given below:

U.S. Pat. No. 8,446,867B2 relates to wireless communications and, more particularly, to a power control method of transmitting data with proper transmission power. It provides a power control method for transmitting data with appropriate transmission power to thereby reduce a path loss or an inter-cell interference. A method of controlling uplink power in a wireless communication system, receiving a power control offset with respect to a data burst including user data from a base station, receiving a power control offset with respect to a control burst including control information from the base station, and controlling transmission power of the data burst and transmission power of the control burst according to the power control offset with respect to the data burst and the power control offset with respect to the control burst.

U.S. Pat. No. 8,725,079B2 discloses an interference analysis tool for identifying an interference problem area in a cellular radio network in which at least a first User Equipment (UE1) and a second UE (UE2) operate. The tool receives signal quality measurements and determines uplink or downlink interference severity. For UE2 uplink interference, the tool determines a first uplink Signal-to-Interference-and-Noise-Ratio (SINR) experienced by UE2, wherein the first SINR includes uplink interference from UE1. The tool also determines a second uplink SINR level (SINR0) experienced by UE2, wherein SINR0 does not include the uplink interference from UE1. The tool calculates a difference (ΔSINR) between SINR and SINR0 for UE2 and identifies the area where UE1 is operating as an interference-causing area when the ΔSINR for UE2 is greater than a threshold value. The tool may present interference severity levels to an operator and may initiate Radio Resource Management (RRM) procedures to mitigate interference problems in the network.

While the prior arts cover various solutions for reducing network power consumption, however, these solutions are not optimized and experience the same drawbacks (as detailed above either in case of closed loop power control mechanism or manual antenna tunning). In light of the above-stated discussion, there is a need to overcome the above stated disadvantages.

### SUMMARY

A principal object of the present disclosure is to provide a method and an apparatus for reducing power in UL (uplink), wherever possible based on different criteria.

Another object of the present disclosure is to provide the method used to reduce over-all interference and improving UL MCS (Uplink Modulation and Coding scheme), UL throughput and spectral efficiency.

Yet another object of the present disclosure is to instruct optimal UL transmission power based on the proposed closed loop power control mechanism.

Accordingly, the present disclosure provides a method for controlling an uplink (UL) transmission power of at least one user equipment (UE) operating in a wireless communication network comprising a plurality of UEs and a base station. The method includes calculating an operating ratio for each UE from said plurality of UEs, determining whether said operating ratio for each UE meets a predefined UL power transmission threshold, and instructing said at least one UE to manage UL transmission power based on said determination.

The method further includes instructing said at least one UE to increase UL transmission power, when said operating ratio of said at least one UE meets said predefined UL power transmission threshold.

The method further includes instructing said at least one UE to decrease UL transmission power, when said operating ratio of said at least one UE fails to meet said predefined UL power transmission threshold.

The method for determining whether said operating ratio for each UE meets a predefined UL power transmission threshold includes comparing each operating ratio for each UE with said predefined UL power transmission threshold, wherein said comparison is based on a path loss for each UE.

The operating ratio comprises a signal quality parameter comprising a Signal-to-Noise Ratio (SINR) and/or a Received Signal Strength Indicator (RSSI) on allocated resource blocks (RBs) to all available RBs in a Bandwidth Part (BWP).

The method for calculating an operating ratio for each UE from said plurality of UEs includes calculating the power of each resource block (RB) of each UE to be transmitted on an uplink transmission channel, wherein said uplink transmission channel is a physical uplink shared channel (PUSCH) and calculating ratio P for each UE, wherein Ratio P is the ratio of allocated resource blocks and the allocated bandwidth part for Received Signal Strength Indicator. The method further includes providing a feedback to said at least one UE, using a transmit power control (TPC) commands, wherein each TPC command is used to control said UL transmission power of said at least one UE, wherein said TPC commands are provided using a closed loop power control mechanism wherein Closed Loop Power Control (CLPC) measurement is used to test the ability of the UE transmitter to adjust its output power in accordance with one or more TPC commands. The power control step is the change in the UE transmitter output power in response to a single TPC command arrived at the UE.

Accordingly, the present disclosure provides a method for controlling an uplink (UL) transmission power of at least one user equipment (UE) operating in a wireless communication network. The method includes receiving instructions, from a base station, indicating UL transmission power for each UE and applying said UL transmission power, for said at least one UE, according to said instructions received from said base station, wherein said UL transmission power is determined by comparing each operating ratio for each UE with said predefined UL power transmission threshold.

The method for applying said UL transmission power, for said at least one UE, according to said instructions received from said base station includes increasing said UL transmission power when said operating ratio of said at least one UE meets said predefined UL power transmission threshold.

The method for applying said UL transmission power, for said at least one UE, according to said instructions received from said base station includes decreasing said UL transmission power when said operating ratio of said at least one UE fails to meet said predefined UL power transmission threshold.

Accordingly, the present disclosure provides a base station for controlling an uplink (UL) transmission power of at least one user equipment (UE) operating in a wireless communication network. The base station comprising a power control unit configured to calculate an operating ratio for each UE from said plurality of UEs, determine whether said operating ratio for each UE meets a predefined UL power transmission threshold, and instruct said at least one UE to manage UL transmission power based on said determination.

Accordingly, the present disclosure provides a user equipment (UE) for controlling an uplink (UL) transmission power in a wireless communication network. The UE comprising a power adaption unit configured to: receive instructions, from a base station, indicating UL transmission power for each UE and apply said UL transmission power, for said at least one UE, according to said instructions received from said base station, wherein said UL transmission power is determined by comparing each operating ratio for each UE with a predefined UL power transmission threshold.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIGS. 1A-1B is a view illustrating a wireless communication implementing a power control mechanism, according to prior art.

FIG. 2A is a view illustrating a wireless communication implementing a power control mechanism, according to the present disclosure.

FIG. 2B illustrates power thresholds, according to the present disclosure.

FIG. 3 illustrates a flowchart of UL transmission power control, according to the present disclosure.

FIG. 4 illustrates various hardware elements of a base station, according to the present disclosure.

FIG. 5 illustrates various hardware elements of the UE, according to the present disclosure.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

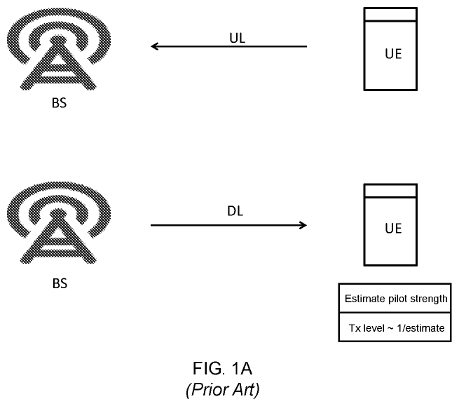

As detailed above (in the background section) in order to provide a power control mechanism that can incorporate varying distance and changing channel conditions, the closed loop power control mechanism is proposed in the art. According to said closed loop power control mechanism, a transmitter (UE) sends a signal to receiver (B S), receivers measure the power of the signal from the transmitter and if the measured power is too low, the receiver sends a special command saying, “increase the power”. In case, if the measured power is too strong, it would send another command saying, “decrease the power”. By this closed loop power control mechanism, the transmitter can change its output power dynamically and the special command being used for power control is called TPC (Transmit Power Control) command. This is illustrated in FIGS. 1A-1B.

However, if the UE transmits the signal at too low power, the BS will not detect it. and if it transmits it in too high power, it can interfere with the communication between other UEs and the BS. Hence, an optimal proper transmit power level is required which would be strong enough to be properly decoded by the BS and weak enough not to interfere the communication between other UEs and the BS.

According to FIG. 1A, first UE will set up the operating point of target power to be received by the BS in the uplink, using Open Loop Power control mechanism. Further, to compensate for any effects such as slow fading etc., said Close Loop power control mechanism (as shown in FIG. 1B) is triggered, once the BS gives feedback using TPC commands. Thus, taking that feedback into account, the UE will increase or decrease its power in the uplink.

Unlike conventional power control mechanisms, the proposed power control mechanism intends to reduce power in UL wherever possible based on different criteria. This reduced power will help to reduce interference in the neighbour cells. Neighbour cells UEs will also reduce their power and that will reduce interference in source cell.

Hence, with proposed power control mechanism, over-all less interference may be observed, thereby improving UL MCS, UL throughput and spectral efficiency.

Further, with the virtue of proposed power control mechanism, the overall UE power consumption may also be minimized, thereby improving UE batter efficiency. Further, in the case of TDD (Time Division Duplex), to meet the same UL capacity, less dedicated symbols are required for UL, No. of downlink symbols can be increased which will also provide higher DL throughput.

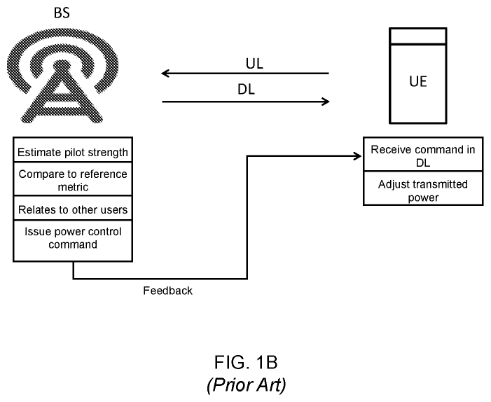

In FIG. 2A, a wireless communication system 100 comprising a base station 102 and a plurality of user equipments (UEs) 104a-104c (interchangeably referred to as UE 104) is illustrated. The wireless communication system 100 may benefit from transmission power control over the uplink via a transmit (Tx) antenna 105. In particular, the UE 104 is responsive to determine that the uplink transmission power is limited by the interference 106 to the neighbouring cell 108.

The base station 102 is generally a fixed station that communicates with the UE 104 and may also be called an access point, a Node B, gNodeB, or some other terminology. The base station 102 provides communication coverage for a particular geographic area. The term “cell” (i.e., neighbouring cell 108) may refer to a base station and/or its coverage area depending on the context in which the term is used.

The UE 104 may also be referred to as an access terminal (AT) or terminal, a mobile station (MS), a subscriber unit, or other appropriate term. The UE 104 may be a cellular phone, a personal digital assistant (PDA), a wireless modem, a wireless communication device, a handheld device, a laptop computer, a netbook, a cordless phone, a wireless local loop (WLL) The UE 104 may communicate with the base station 102 on the downlink and uplink. The downlink (or forward link) refers to the communication link from the base station to the terminal, and the uplink (reverse link) refers to the communication link from the terminal to the base station 102.

In power control scenario for interference-limited network 100, the interference to other cells 108 should be tightly controlled. It should be appreciated that interest in total emitted power control is an advantage of the present disclosure. According to 3GPP standards, there exists two power control mechanisms such as the open loop power control and closed loop power control mechanism.

In some aspects, power control in the uplink on the PUSCH depends on the factors comprising at least one of the amount of data, number of Resource Blocks (RBs), Modulation and Coding Scheme (MC S), path loss, conventional power control, fractional power control and TPC commands. In particular, the uplink power needs to be only minimally required as needed to avoid interference and decrease UE 104 battery consumption. The power on uplink PUSCH=Min (UE max power, power computed through dependency factors (amount of data, number of resource blocks, modulation and coding scheme, path loss, conventional power control, fractional power control, TPC command), as described below in equation (1).

PPUSCH=min{Pcmax,10×LOG(MPUSCH(i))+PO_PUSCH(i)+[PL×α(i)]+ΔTF(i)+f(i) Equation (1).

where,
PCMAX=configured UE transmitted max power defined in TS 36.101
Po_PUSCH=Target Power Spectral Density
MPUSCH=Number of assigned resource blocks
PL=Estimated Downlink Path Loss
α=Factor to enable or disable Fractional Power Control (also termed as Cell Specific factor)
f(i)=Closed loop component of Power control (TPC commands)
ΔTF=Modulation and coding scheme (transport format-depending compensation)

The Open loop power control is dependent upon the factors which affect power control. Example of the factors which only affect the Open Loop Power Control for PUSCH is described above and is illustrated below in equation (2).

P calculated_open_loop=10*LOG(# of Resource Blocks)+Power needed at gNodeB+(Path Loss*Factor to Enable or Disable Fractional Power Control)+MCS Equation (2).

Number of Resource Blocks for PUSCH=MPUSCH.

MPUSCH is the PUSCH bandwidth during subframe ‘i’ expressed in terms of Resource Blocks. This variable is used to increase the UE 104 transmit power for larger resource block allocations. The UE 104 transmit power is increased in direct proportion to the number of allocated Resource Blocks.

Thus, the transmit power per Resource Block remains constant if other factors remain fixed. This is also referred to as maintaining a constant power spectral density.

In some aspects, the path loss is the downlink path loss calculated by the UE 104 as a combination of RSRP (Reference Signal Received Power) measurements and knowledge of the Reference Signal Transmit Power.

PL=Reference Signal Transmit Power— RSRP measurements.

The Reference Signal Transmit Power is broadcasted within SIB 2 and can also be signalled with an RRC (Radio Resource Control) Connection Reconfiguration message. Its value ranges from −60 to 50 dBm.

The power needed at gNodeB 102=Po_PUSCH. Po_PUSCH represents the gNodeB 102 received power per Resource Block assuming a path loss of 0 dB. The received power per resource block is maintained as the path loss increases when using conventional power control alone. The received power per resource block is decreased as the path loss increases when using fractional power control.

Factor to enable or disable Fractional Power Control=α. Alpha (α) is used to configure the use of fractional power control. This is the same variable as that used by the gNodeB when calculating Po_PUSCH. A value of 1 disables fractional power control. The Alpha can have a range of values from 0,0.4,0.5,0.6,0.7,0.8,0.9 and 1.

Modulation and Coding Scheme=ΔTF

In some aspect, the MCS increases the UE 104 transmit power when transferring a large number of bits per resource element. This links the UE 104 transmit power to the MCS. The number of bits per resource element is high when using 64 QAM (Quadrature Amplitude Modulation) and a large transport block size. The number of bits per resource element is low when using QPSK (Quadrature Phase Shift Keying) and a small transport block size. Increasing the UE 104 transmit power helps to achieve the SINR requirements associated with higher order modulation schemes and high coding rates.

The transmission power using said open loop power control can therefore be calculated by using equation (3) which is a combination of equations (1) and (2).

PCALCULATED_OPEN_LOOP=10×LOG(MPUSCH)+PO_PUSCH+[PL×α]+ΔT Equation (3).

In some aspects, the Closed loop power control depends on the gNodeB 102 providing feedback to the UE 104 in the form of Transmit Power Control (TPC) commands.

In some aspects, the TPC commands are signalled to the UE within the following Downlink Control Information (DCI) formats: DCI format 0, DCI format 3, DCI format 3A and DCI format 4. Further, interpretation and application of said TPC commands depends on if either accumulation mode is enabled or not. The UE 104 may be instructed about setting it up or not in RRC messages.

Table. 1 below illustrates the mapping of TPC command field in a DCI format scheduling a PUSCH transmission, or in DCI format 2_2 with CRC scrambled by TPC-PUSCH-RNTI, or in DCI format 2_3, to absolute and accumulated ∂PUSCH, b,f,c values or ∂SRS, b,f,c values.

TABLE 1

| TPC | Accumulated ∂_{PUSCH, b, f, c} | Absolute ∂_{PUSCH, b, f, c} |
|---|---|---|
| command field | OR ∂_{SRS, b, f, c} [DB] | OR ∂_{SRS, b, f, c} [DB] |
| 0 | −1 | −4 |
| 1 | 0 | −1 |
| 2 | 1 | 1 |
| 3 | 3 | 4 |

In accordance with various aspects, the UE 104 may be provided with an estimate of reverse-link quality for base station 102. In the event that the base station 102 transmits back an erasure indicator of each CQI/DRC transmission, the UE 104 may autonomously derive a scalable power-boosting factor that better matches the channel condition.

Accordingly, a reverse link control channel power control may be performed using closed loop power control mechanism, whereby the UE 104 targets a certain performance for these channels (e.g., PUSCH) and issues power control commands (i.e., TPC) for each UE from a set of UEs 104a-104c separately, instructing them to increase or decrease their transmit powers to meet the performance requirements. In an aspect, these power control commands are either erasure indications for the most recent transmissions of the CQI (Channel Quality Indicator) information from the UE 104, or up/down commands issued based on targeting a certain received carrier to interference ratio (C/I) on the reverse link CQI channels from the UE 104.

In view of the above-described open loop power control and closed loop power control, the UE 104 may be configured, at first, to set up the operating point of “target power” to be received by the gNodeB 102 in the UL using the open loop power control.

Further, in order to compensate for any effects such as slow fading, interference 106 from neighbouring cell 108, etc. Since higher transmitted power in UL by cell edge users will create high interference to the neighbouring cell 108. More particularly, in the high dense urban scenario, this will overweigh the impact of own cell gain in comparison with the interference generated by UEs 104a-104c from neighbour cell(s) 108.

Hence, in order to avoid the interference issues and further to enable optimize UL transmission power, the UE 104 may be configured to, at second, implement/set-up the closed loop power control upon receiving the TPC commands from the gNodeB 102. In some aspect, the base station 102 may be configured to calculate an operating ratio for each UE from the plurality of UEs 104a-104c. That is, once the RBs are allocated by a scheduler of the BS 102 for UL data transmission, a power control unit of the BS 102 may determine from LA entity the average cell interference and interference measured on the allocated resource. In some aspects, the operating ratio can be calculated by calculating the power of each RB of each UE 104 to be transmitted on the uplink transmission channel i.e., PUSCH. The PUSCH is the physical channel that carries the user data. The resources allocated for PUSCH are within the bandwidth part (BWP) of the carrier. Accordingly, the UL transmission power is controlled using the closed loop power control mechanism using equation (4), shown below.

$$\text{?} ( i , j , {q}_{d} , l ) = min \{ \begin{matrix}\text{?} ( i ) , \\ \text{?} ( j ) + 10 {log}_{10} ( \text{?} ( i ) ) + \text{?} ( j ) \cdot \text{?} ( {q}_{d} ) + \text{?} ( i ) \text{?}\end{matrix} \} [ dBm ]$$

$$\text{?} \text{indicates text missing or illegible when filed}$$

where, P_{CMAX,f,c}(i) is the UE configured maximum output power defined in [8-1, TS 38.101-1], [8-2, TS38.101-2] and [8-3, TS38.101-3] for carrier f of serving cell c in PUSCH transmission occasion i. P_{O_PUSCH,b,f,c}(j) is a parameter composed of the sum of a component P_{O_NOMINAL_PUSCH,f,c}(j) and a component P_{O_UE_PUSCH,b,f,c}(j) where j ∈{0,1, . . . J−1}.

M_{RB,b,f,c}^{PUSCH} (i) is the bandwidth of the PUSCH resource assignment expressed in number of resource blocks for PUSCH transmission occasion i on active UL BWP b of carrier f of serving cell c and μ is an SCS configuration defined in [4, TS 38.211]. PL_{b,f,c}(q_{d}) is a downlink pathloss estimate in dB calculated by the UE using reference signal (RS) index q_{d} for the active DL BWP of carrier f of serving cell c.

In some aspects, both the BS 102 and the UE 104 may support RSSI/SINR measurements at the granularity of resource block group or RB level.

Thus, in some aspects, the power control unit of the BS 102 may be configured to determine whether said operating ratio for each UE 104 meets a predefined UL power transmission threshold. That is, the power control unit compares the RSSI value on allocated RBs to the overall BWP average SINR value: This ratio is known as ratio_P (i.e., operating ratio)=RSSI (allocated RBs)/RSSI(BWP).

In some aspects, the Receive Strength Signal (RSSI) indicator measures the average total received power of the whole band. The carrier RSSI measures the average total received power observed, but only uses OFDM (Orthogonal Frequency Division Multiplexing) symbols containing reference symbols for antenna port 0, i.e., OFDM symbol 0 & 4 in a slot, in the measurement bandwidth over N resource blocks. The total received power of the carrier RSSI includes the power from non-serving cells and co-channel serving, adjacent channel interference, thermal noise, etc. The total is measured over 12-subcarriers, including RS from Serving Cell and Traffic in the Serving Cell. RSSI is a parameter which provides information about the total received wide-band power measure in all symbols, including all thermal and interference noise. RSSI (wideband power)=serving cell power+interference power+noise.

Further, the Signal to Noise Ratio (SINR) is derived from the desired signal divided by undesired noise. It looks at the signal as related to noise. The SINR is the reference value used in system simulation and can be defined as Wideband SINR. The SINR is for a specific resource element or a specific subcarrier. Although the SINR is also a measure of signal quality, it is not defined in the 3GPP specs, but by the UE vendor and it is therefore not reported to the network. The SINR is used by the LTE (Long Term Evolution) industry in general and by many operators, as it quantifies the relationship between throughput and RF conditions better. The LTE UEs normally use SINR to calculate the CQI (Channel Quality Indicator) that is reported to the network. The SINR as an indicator is commonly used for network quality. It should however be noted that SINR is not specified by 3GPP and UEs therefore do not report SINR to networks. The SINR is however measured internally by most UEs (104a-104c) and recorded to be used by test tools.

Further, the BS 102 may be configured to instruct said at least one UE 104 to manage UL transmission power based on said determination of the operating ratio. Thus, the BS 102 may instruct the UE 104 to increase UL transmission power, when said operating ratio of the UE 104 meets said predefined UL power transmission threshold. Further, the BS 102 may instruct the UE 104 to decrease UL transmission power, when said operating ratio of the UE 104 fails to meet said predefined UL power transmission threshold.

For example, the correction of UL transmission power based on said UL power transmission threshold comprises determining: if ratio_P is >1.5 then there will be a correction (increase/decrease) in existing power command of −1 dB provided SINR of allocated RBs is greater than average. Further, if ratio_P is <0.7 then there will be correction in the existing power command of +1 dB provided SINR of allocated RBs is less than average. Furthermore, if the ratio_P is <0.5 then there will be a correction in the existing power command of +2 dB provided SINR of allocated RBs is less than average. Thus, a new TPC bit may be rounded off to the near value as per the 3GPP Table. 1 (shown above).

In some aspects, the BS 102 provides feedback to said UE 104, using the TPC commands, where each TPC command comprises power configuration (as instructed by the BS 102) that is received and adapted by the UE 104.

The proposed closed loop power control method may be summarized as: a) The UE 104 calculates transmitted power from the open loop power control equation. 2) The base station 102 generates the feedback for the close loop power control and sends Transmit Power Control (TPC bit) to the UE 102 to update UE's transmission power as per configured power thresholds. 3) The base station 102 fine-tunes the calculated feedback (TPC command) as per ratio_P to minimize interference in neighbour cell 108. 4) Resource blocks are allocated to the UE 104 by the base station 102 in DL/UL to transmit/receive any data. 5) The base station 102 compares the UL RSSI indicator value on the UE's allocated RBs to all available RBs, in particular, BWP (Bandwidth Part), this ratio is known as ratio_P (or operating ratio)=RSSI (allocated RBs)/RSSI(BWP).

Unlike conventional power control mechanisms, the base station 102 fine-tunes the calculated feedback (TPC command) as per ratio_P to minimize interference in neighbor cell(s) 108.

Unlike conventional power control mechanism, the base station 102 compares the UL RSSI value on UE's allocated RBs to all available RBs to calculate optimal power value for the UE 104.

FIG. 2B illustrates the power thresholds. In that the BS 102 measures UE 104 SINR/RSSI and compare with configured thresholds and instructs (using power commands) the UE 104 to increase/decrease the Tx power. For example, Power Command:
0 dB: when RSSI/SINR is within both window
−1 dB: RSSI/SINR both exceeding window OR RSSI within the window, SINR exceeding window OR SINR within the window, RSSI exceeding window
+1 dB: RSSI/SINR one OR both below the window
+3 dB: RSSI/SINR one OR both below window by >1 dB.

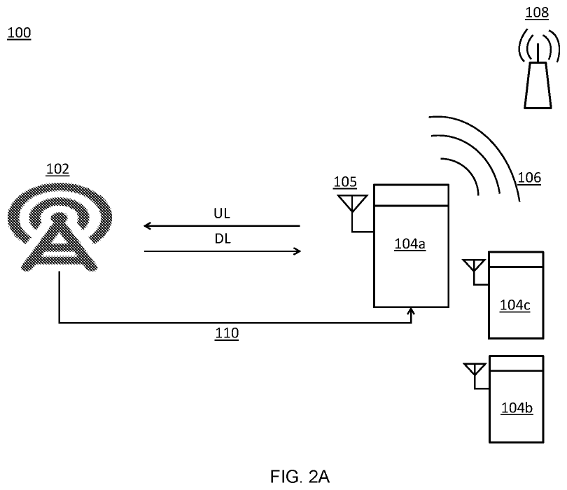

FIG. 3 illustrates a flowchart 300 of the UL transmission power control. It may be noted that in order to explain the method steps of the flowchart 300, references will be made to the elements explained in FIG. 2A.

At step 302, the method includes calculating the operating ratio for each UE from said plurality of UEs 104a-104c. At step 304, the method includes determining whether said operating ratio for each UE 104 meets the predefined UL power transmission threshold. At step 306, the method includes instructing said UE 104 to increase UL transmission power, when said operating ratio of said UE 104 meets said predefined UL power transmission threshold. At step 308, the method includes instructing said UE 104 to decrease UL transmission power, when said operating ratio of said UE 104 fails to meet said predefined UL power transmission threshold.

It may be noted that flowchart 300 is explained to have above stated process steps; however, those skilled in the art would appreciate that flowchart 300 may have more/less number of process steps which may enable all the above stated implementations of the present disclosure.

The various actions acts, blocks, steps, or the like in the flow chart may be performed in the order presented, in a different order or simultaneously. Further, in some implementations, some of the actions, acts, blocks, steps, or the like may be omitted, added, modified, skipped, or the like without departing from the scope of the invention.

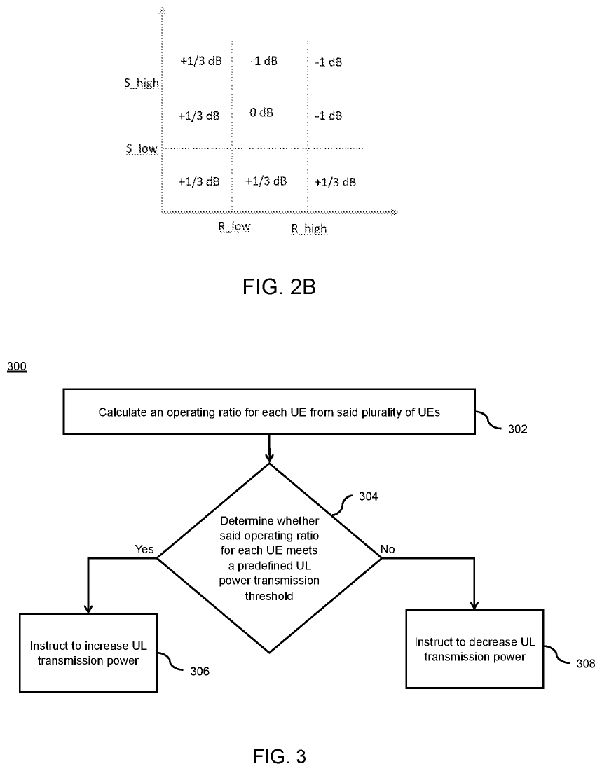

FIG. 4 illustrates various hardware elements of said BS 102, according to the present disclosure.

Referring to FIG. 4, various hardware elements of said base station 102 include a transceiver 402, at least one processor and/or power control unit 404, and a storage unit 406. However, the components of the base station 102 are not limited to the above-described example, and for example, the BS 102 may include more or fewer components than the illustrated components. In addition, the transceiver 402, the storage unit 406, and the power control unit 404 may be implemented in the form of a single chip.

The transceiver 402 may transmit and receive signals to and from a terminal i.e., UE 104. Here, the signal may include control information and data. To this end, the transceiver 402 may include an RF (radio frequency) transmitter that upconverts and amplifies a frequency of a transmitted signal, and an RF receiver that amplifies a received signal with low noise and down converts a frequency. Alternatively, the RF transmitter and RF receiver, of said transceiver 402, may together be referred to as said TRX radio module. However, this is only an example component of the transceiver 402, and components of the transceiver 402 are not limited to the RF transmitter and the RF receiver. In addition, the transceiver 402 may receive a signal through a wireless channel, output the same to the power control unit 404, and transmit the signal output from the power control unit 404 through a wireless channel. In addition, the transceiver 402 may separately include an RF transceiver for an LTE system and an RF transceiver for an NR (New Radio) system or may perform physical layer processing of LTE and NR with one transceiver.

The storage unit 406 may store programs and data necessary for the operation of the power control unit 404 of the base station 102. In addition, the storage unit 406 may store control information or data included in signals transmitted and received by the base station. The storage unit 406 may be composed of a storage medium such as read only memory (ROM), random access memory (RAM), hard disk, compact disc ROM (CD-ROM), and digital versatile disc (DVD), or a combination of storage media. Also, there may be a plurality of storage units 406.

The power control unit 404 may control a series of processes so that the base station 102 can operate according to the description described above. For example, the power control unit 404 may calculate the operating ratio for each UE from said plurality of UEs 104a-104c, determine whether said operating ratio for each UE 104 meets the predefined UL power transmission threshold and instruct said UE 104 to manage UL transmission power based on said determination. There may be a plurality of power control units 404, and the power control unit 404 may perform a component control operation of the base station 102 by executing a program stored in the storage unit 406.

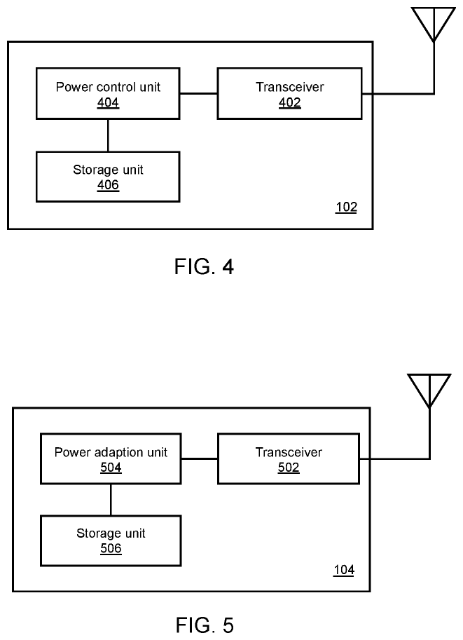

FIG. 5 illustrates various hardware elements of said UE 104, according to the present disclosure.

Referring to FIG. 5, various hardware elements of said UE 104 includes a transceiver 502, at least one processor and/or power adaption unit 504, and a storage unit 506. However, the components of said UE 104 are not limited to the above-described example, and for example, said UE 104 may include more or fewer components than the illustrated components. In addition, the transceiver 502, the storage unit 506, and the power adaption unit 504 may be implemented in the form of a single chip.

The transceiver 502 may transmit and receive signals to and from the BS 102. Here, the signal may include control information, TPC commands, and data. To this end, the transceiver 502 may include an RF transmitter that upconverts and amplifies a frequency of a transmitted signal, and an RF receiver that amplifies a received signal with low noise and down converts a frequency. Alternatively, the RF transmitter and RF receiver, of said transceiver 502, may together be referred to as said TRX radio module. However, this is only an example component of the transceiver 502, and components of the transceiver 502 are not limited to the RF transmitter and the RF receiver. In addition, the transceiver 502 may receive a signal through a wireless channel, output the same to the power adaption unit 504, and transmit the signal output from the power adaption unit 504 through a wireless channel. In addition, the transceiver 502 may separately include an RF transceiver for an LTE system and an RF transceiver for an NR system or may perform physical layer processing of LTE and NR with one transceiver.

The storage unit 506 may store programs and data necessary for the operation of the power adaption unit 504. In addition, the storage unit 506 may store control information or data included in signals transmitted and received by the UE 104. The storage unit 506 may be composed of a storage medium such as read only memory (ROM), random access memory (RAM), hard disk, compact disc ROM (CD-ROM), and digital versatile disc (DVD), or a combination of storage media. Also, there may be a plurality of storage units 506.

The power adaption unit 504 may control a series of processes so that the UE 104 may operate according to the description described above. For example, the power adaption unit 504 may receive instructions, from the base station 102 indicating UL transmission power and apply said UL transmission power according to said instructions received from said base station 102. The UL transmission power is determined by comparing each operating ratio for each UE with the predefined UL power transmission threshold. There may be a plurality of power adaption unit 504, and the power adaption unit 504 may perform a component control operation of the UE 104 by executing a program stored in the storage unit 506.

The embodiments/aspects disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repository, such as relational databases and flat file systems that use volatile and/or non-volatile memory (e.g., magnetic disk storage, optical storage, EEPROM and/or solid-state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey those certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

We claim:

1. A method for controlling an uplink (UL) transmission power of at least one user equipment (UE) operating in a wireless communication network (100) comprising a plurality of UEs (104a-104c) and a base station (102), the method comprising:
calculating an operating ratio for each UE from said plurality of UEs (104a-104c);
determining whether said operating ratio for each UE meets a predefined UL power transmission threshold; and
instructing said at least one UE to manage UL transmission power based on said determination.

2. The method as claimed in claim 1, wherein instructing said at least one UE to manage UL transmission power based on said determination comprising:
instructing said at least one UE to increase UL transmission power, when said operating ratio of said at least one UE meets said predefined UL power transmission threshold;
instructing said at least one UE to decrease UL transmission power, when said operating ratio of said at least one UE fails to meet said predefined UL power transmission threshold.

3. The method as claimed in claim 1, wherein determining whether said operating ratio for each UE meets a predefined UL power transmission threshold comprises: comparing each operating ratio for each UE with said predefined UL power transmission threshold, wherein said comparison is based on a path loss for each UE.

4. The method as claimed in claim 1, wherein said operating ratio comprises a signal quality parameter comprising a Signal-to-Noise Ratio (SINR) and/or a Received Signal Strength Indicator (RSSI) on allocated resource blocks (RBs) to all available RBs in a Bandwidth Part (BWP).

5. The method as claimed in claim 1, wherein calculating an operating ratio for each UE from said plurality of UEs comprises:
calculating power of each resource block (RB) of each UE to be transmitted on an uplink transmission channel, wherein said uplink transmission channel is a physical uplink shared channel (PUSCH); and
calculating ratio P for each UE, wherein Ratio P is the ratio of allocated resource blocks and the allocated bandwidth part for Received Signal Strength Indicator.

6. The method as claimed in claim 1, wherein said instructing said at least one UE to manage UL transmission power based on said determination comprises:
providing a feedback to said at least one UE, using a transmit power control (TPC) commands, wherein each TPC command is used to control said UL transmission power of said at least one UE, wherein said TPC commands are provided using a closed loop power control mechanism.

7. A method for controlling an uplink (UL) transmission power of a user equipment (UE) from a plurality of UEs (104a-104c) operating in a wireless communication network (100) the method comprising:
receiving instructions, from a base station (102), indicating UL transmission power for each UE; and
applying said UL transmission power, for said at least one UE, according to said instructions received from the said base station (102), wherein said UL transmission power is determined by comparing each operating ratio for each UE with a predefined UL power transmission threshold.

8. The method as claimed in claim 7, wherein applying said UL transmission power, for said at least one UE, according to said instructions received from said base station comprising:
increasing said UL transmission power when said operating ratio of said at least one UE meets said predefined UL power transmission threshold; and
decreasing said UL transmission power when said operating ratio of said at least one UE fails to meet said predefined UL power transmission threshold.

9. The method as claimed in claim 7, wherein said operating ratio comprises a signal quality parameter comprising a Signal-to-Noise Ratio (SINR) and/or a Received Signal Strength Indicator (RSSI) on allocated resource blocks (RBs) to all available RBs in a Bandwidth Part (BWP).

10. The method as claimed in claim 7, wherein said comparison is based on a path loss for each UE.

11. A base station (102) for controlling an uplink (UL) transmission power of at least one user equipment (UE) operating in a wireless communication network (100) comprising a plurality of UEs (104a-104c) and said base station (102), the base station (102) comprising a power control unit (404) configured to:
calculate an operating ratio for each UE from said plurality of UEs (104a-104c);
determine whether said operating ratio for each UE meets a predefined UL power transmission threshold; and
instruct said at least one UE to manage UL transmission power based on said determination.

12. The base station (102) as claimed in claim 11, wherein instructing said at least one UE to manage UL transmission power based on said determination comprising:
instructing said at least one UE to increase UL transmission power, when said operating ratio of said at least one UE meets said predefined UL power transmission threshold;
instructing said at least one UE to decrease UL transmission power, when said operating ratio of said at least one UE fails to meet said predefined UL power transmission threshold.

13. The base station (102) as claimed in claim 11, wherein determining whether said operating ratio for each UE meets a predefined UL power transmission threshold comprises: comparing each operating ratio for each UE with said predefined UL power transmission threshold, wherein said comparison is based on a path loss for each UE.

14. The base station (102) as claimed in claim 11, wherein said operating ratio comprises a signal quality parameter comprising a Signal-to-Noise Ratio (SINR) and/or a Received Signal Strength Indicator (RSSI) on allocated resource blocks (RBs) to all available RBs in a Bandwidth Part (BWP).

15. The base station (102) as claimed in claim 11, wherein calculating an operating ratio for each UE from said plurality of UEs comprises:
calculating power of each resource block (RB) of each UE to be transmitted on an uplink transmission channel, wherein said uplink transmission channel is a physical uplink shared channel (PUSCH); and
calculating ratio P for each UE, wherein the Ratio P is the ratio of allocated resource blocks and the allocated bandwidth part for Received Signal Strength Indicator.

16. The base station (102) as claimed in claim 11, wherein said instructing said at least one UE to manage UL transmission power based on said determination comprises:
providing a feedback, to said at least one UE, using a transmit power control (TPC) commands, wherein each TPC command is used to control said UL transmission power of said at least one UE, wherein said TPC commands are provided using a closed loop power control mechanism.

17. A UE for controlling an uplink (UL) transmission power operating in a wireless communication network (100) comprising a plurality of UEs (1014a-104c), the UE comprising a power adaption unit (504) configured to:
receive instructions, from a base station (102), indicating UL transmission power for each UE;
applying said UL transmission power, for said at least one UE, according to said instructions received from the said base station (102), wherein said UL transmission power is determined by comparing each operating ratio for each UE with said predefined UL power transmission threshold.

18. The UE as claimed in claim 17, wherein applying said UL transmission power, for said at least one UE, according to said instructions received from said base station comprising:
increasing said UL transmission power when said operating ratio of said at least one UE meets said predefined UL power transmission threshold; and
decreasing said UL transmission power when said operating ratio of said at least one UE fails to meet said predefined UL power transmission threshold.

19. The UE as claimed in claim 17, wherein said operating ratio comprises a signal quality parameter comprising a Signal-to-Noise Ratio (SINR) and/or a Received Signal Strength Indicator (RSSI) on allocated resource blocks (RBs) to all available RBs in a Bandwidth Part (BWP).

20. The UE as claimed in claim 17, wherein said comparison is based on a path loss for each UE.
